(19) United States
(12) Patent Application Publication
(10) Pub. No.: US 2024/0386807 A1
(43) Pub. Date: Nov. 21, 2024

(54) SYSTEM, METHOD, AND COMPUTER PROGRAM FOR TECHNICAL ACCELERATOR LEARNING ENVIRONMENT

(71) Applicant: JPMorgan Chase Bank, N.A., New York, NY (US)

(72) Inventors: Grzegorz STENCEL, Bournemouth (GB); Shailesh SHRESTHA, London (GB); Dennis MARTIN, Outwood (GB)

(73) Assignee: JPMorgan Chase Bank, N.A., New York, NY (US)

(21) Appl. No.: 18/197,496

(22) Filed: May 15, 2023

(51) Int. Cl. G09B 5/02; H04L 9/40

(52) U.S. Cl. CPC G09B 5/02; H04L 63/08

(57) ABSTRACT

Various methods, apparatuses/systems, and media for implementing a platform for self-learning technologies are disclosed. A processor builds a plurality of containers each including self-learning instructions and tutorials corresponding to a particular internal or new organization specific technology; implements a process to configure each container in a manner such that each container can be hosted on an isolated learning environment; receives, via a browser, user input corresponding to login credentials associated with the user; receives, upon successful login, user requests that identify user desired instructions and tutorials corresponding to the particular internal or new organization specific technology; automatically provisions, in response to receiving the user requests, the isolated learning environment for hosting the processed containers that include the identified user desired instructions and tutorials; and allows the user to self-learn, by utilizing the isolated learning environment, the particular internal or new organization specific technology.

### TECHNICAL FIELD

This disclosure generally relates to self-learning systems and methods, and, more particularly, to methods and apparatuses for implementing a platform, language, cloud, and database agnostic technology learning module configured to create a technical accelerator learning environment that provides an immersive, hands-on practical learning environment that allows users to experience new technologies safely, securely, confidently, and at their own pace.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

In the world we live in today, we're spoilt for choice when it comes to new technology and innovations, and it's the same within an organization. For example, employees of an organization are often faced with a daunting task of learning internal technologies and/or new organization specific technologies, that are not otherwise available at other learning environments outside of the organization's internal network. Today, there appears to be many learning barriers for users (i.e., software developers) of the organization, such as complex processes to set up learning environments, lengthy pre-requisites, and long approval delays.

Typically, an organization may customize standard software, such as Kubernetes solution, within the organization's private cloud environment for a variety of reasons including regulatory, security and compatibility. Existing skills-gap training courses within solutions may require time-consuming set up and software installations to meet the pre-requisites to begin the activities and even sometimes requiring entitlements or onboarding activities adding to long approval delays and complexities. Moreover, knowledge tests performed via external tools such have restrictions around the use of the organization's keywords and internal processes. To meet the demands of planning may public cloud projects within the organization, it became imperative to upskill employees, particularly software developers, so that they may be able to gain hands-on knowledge safely, securely, confidently, and at their own pace to modernize applications.

Thus, there is a need for an advanced tool and method that can address these conventional shortcomings corresponding to self-learning systems and methods.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic technology learning module configured to create a technical accelerator learning environment that provides an immersive, hands-on practical learning environment that allows users, i.e., software developers, to experience new technologies and internal technologies safely, securely, confidently, and at their own pace, but the disclosure is not limited thereto.

For example, the present disclosure, through one or more of its various aspects, embodiments, and/or specific features or sub-components, provides, among other features, various systems, servers, devices, methods, media, programs, and platforms for implementing a platform, language, database, and cloud agnostic technology learning module configured to: improve the user experience and help users gain hands-on knowledge to modernize applications: offer support for those who are new to an organization and public cloud all the way through to those who have extensive experience of both: support public cloud environment to unlock public cloud at scale that is needed to provide the ability for users to learn through hands-on practical experiences, and to easily apply that knowledge efficiently and effective: provide learning experiences accessible to all irrespective of their desktop infrastructure, role, and tenure: support experimentation and exploration through disposable environments: support learning experiences anytime, anywhere at the time of need-users can start learning in seconds or minutes with no pre-requisites (i.e., entitlements or onboarding activities, etc.); provide locked down, isolated environments ensuring learners only have access to what they need-no risk of destroying their own development environments: provide a zero-install model with no local infrastructure requirements-everything may be accessible from a browser so that every logged in user doesn't need to request for any accesses or install anything: provide organization specific step-by-step tutorials to users of all abilities, roles, or tenures across a variety of topics, etc., but the disclosure is not limited thereto.

According to exemplary embodiments, a method for implementing a platform for self-learning technologies by utilizing one or more processors along with allocated memory is disclosed. The method may include: building a plurality of containers each including self-learning instructions and tutorials corresponding to a particular internal or new organization specific technology needed to be learned by a user that are not otherwise available via a third party learning platform: implementing a process to configure each container in a manner such that each container can be hosted on an isolated learning environment: hosting, in response to implementing the process, each processed container onto a public cloud environment and a private cloud environment: receiving, via a browser, user input corresponding to login credentials associated with the user; receiving, upon successful login, user requests that identify user desired instructions and tutorials corresponding to the particular internal or new organization specific technology: automatically provisioning, in response to receiving the user requests, the isolated learning environment for hosting the processed containers that include the identified user desired instructions and tutorials; and automatically implementing a platform that allows the user to self-learn, by utilizing the isolated learning environment, the particular internal or new organization specific technology.

According to exemplary embodiments, the method may further include linking the processed containers with an identity provider, wherein the identify provider verifies the login credentials for allowing access to the processed containers, and once logged in, the user does not need to request any access permissions or install any tools or applications onto the user's own workspace development environment for accessing other processed containers.

According to exemplary embodiments, the method may further include automatically provisioning the isolated learning environment in a manner such that the provisioned learning environment enables a user to access or open files from the processed container to self-learn the particular internal or new organization specific technology based on corresponding instructions and tutorials without affecting the user's own workspace development environment.

According to exemplary embodiments, in the method, the browser is operatively connected to the private cloud environment and the public cloud environment.

According to exemplary embodiments, in the method, each of the private cloud environment and the public cloud environment is stateless or ephemeral such that each request sent between a sender and a receiver can be interpreted and does not need earlier requests for its execution.

According to exemplary embodiments, the method may further include asynchronously provisioning the isolated learning environment exclusive to said user instantaneously.

According to exemplary embodiments, the method may further include establishing a connection to the isolated learning environment via a uniform resource locator link through the browser; and allowing access to the corresponding processed containers to self-learn the particular internal or new organization specific technology based on corresponding instructions and tutorials at the user's own pace.

According to exemplary embodiments, the method may further include invoking corresponding provisioning application programming interface to automatically provision the isolated learning environment exclusive to said user based on the identified user desired instructions and tutorials.

According to exemplary embodiments, the method may further include automatically provisioning corresponding isolated learning environment for each user in a multi-tenant configuration as a dedicated environment such that users can spin up or tear down the dedicated environment on demand.

According to exemplary embodiments, the method may further include hosting the isolated learning environment onto the private cloud and the public cloud in a manner such that the users can access the processed containers having corresponding instructions and tutorials directly, wherein there is no contention for resources because each user gets a dedicated learning environment.

According to exemplary embodiments, a system for implementing a platform for self-learning technologies is disclosed. The system may include: a processor; and a memory operatively connected to the processor via a communication interface, the memory storing computer readable instructions, when executed, may cause the processor to: build a plurality of containers each including self-learning instructions and tutorials corresponding to a particular internal or new organization specific technology needed to be learned by a user that are not otherwise available via a third party learning platform: implement a process to configure each container in a manner such that each container can be hosted on an isolated learning environment: host, in response to implementing the process, each processed container onto a public cloud environment and a private cloud environment: receive, via a browser, user input corresponding to login credentials associated with the user: receive, upon successful login, user requests that identify user desired instructions and tutorials corresponding to the particular internal or new organization specific technology: automatically provisions, in response to receiving the user requests, the isolated learning environment for hosting the processed containers that include the identified user desired instructions and tutorials; and automatically implement a platform that allows the user to self-learn, by utilizing the isolated learning environment, the particular internal or new organization specific technology.

According to exemplary embodiments, the processor may be further configured to: link the processed containers with an identity provider, wherein the identify provider verifies the login credentials for allowing access to the processed containers, and once logged in, the user does not need to request any access permissions or install any tools or applications onto the user's own workspace development environment for accessing other processed containers.

According to exemplary embodiments, the processor may be further configured to: automatically provision the isolated learning environment in a manner such that the provisioned learning environment enables a user to access or open files from the processed container to self-learn the particular internal or new organization specific technology based on corresponding instructions and tutorials without affecting the user's own workspace development environment.

According to exemplary embodiments, the processor may be further configured to: asynchronously provision the isolated learning environment exclusive to said user instantaneously.

According to exemplary embodiments, the processor may be further configured to: establish a connection to the isolated learning environment via a uniform resource locator link through the browser; and allow access to the corresponding processed containers to self-learn the particular internal or new organization specific technology based on corresponding instructions and tutorials at the user's own pace.

According to exemplary embodiments, the processor may be further configured to: invoke corresponding provisioning application programming interface to automatically provision the isolated learning environment exclusive to said user based on the identified user desired instructions and tutorials.

According to exemplary embodiments, the processor may be further configured to: automatically provision corresponding isolated learning environment for each user in a multi-tenant configuration as a dedicated environment such that users can spin up or tear down the dedicated environment on demand.

According to exemplary embodiments, the processor may be further configured to: host the isolated learning environment onto the private cloud and the public cloud in a manner such that the users can access the processed containers having corresponding instructions and tutorials directly, wherein there is no contention for resources because each user gets a dedicated learning environment.

According to exemplary embodiments, a non-transitory computer readable medium configured to store instructions for implementing a platform for self-learning technologies is disclosed. The instructions, when executed, may cause a processor to perform the following: building a plurality of containers each including self-learning instructions and tutorials corresponding to a particular internal or new organization specific technology needed to be learned by a user that are not otherwise available via a third party learning platform; implementing a process to configure each container in a manner such that each container can be hosted on an isolated learning environment: hosting, in response to implementing the process, each processed container onto a public cloud environment and a private cloud environment: receiving, via a browser, user input corresponding to login credentials associated with the user; receiving, upon successful login, user requests that identify user desired instructions and tutorials corresponding to the particular internal or new organization specific technology: automatically provisioning, in response to receiving the user requests, the isolated learning environment for hosting the processed containers that include the identified user desired instructions and tutorials; and automatically implementing a platform that allows the user to self-learn, by utilizing the isolated learning environment, the particular internal or new organization specific technology.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic technology learning module configured to create a technical accelerator learning environment that provides an immersive, hands-on practical learning environment with an exemplary embodiment.

FIG. 2 illustrates an exemplary diagram of a network environment with a platform, language, database, and cloud agnostic technology learning device in accordance with an exemplary embodiment.

FIG. 3 illustrates a system diagram for implementing a platform, language, database, and cloud agnostic technology learning device having a platform, language, database, and cloud agnostic technology learning module in accordance with an exemplary embodiment.

FIG. 4 illustrates a system diagram for implementing a platform, language, database, and cloud agnostic technology learning module of FIG. 3 in accordance with an exemplary embodiment.

FIG. 5 illustrates an exemplary architecture implemented by the platform, language, database, and cloud agnostic technology learning module of FIG. 4 for creating a technical accelerator learning environment in accordance with an exemplary embodiment.

FIG. 6 illustrates an exemplary flow chart of a process implemented by the platform, language, database, and cloud agnostic technology learning module of FIG. 4 for creating a technical accelerator learning environment in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

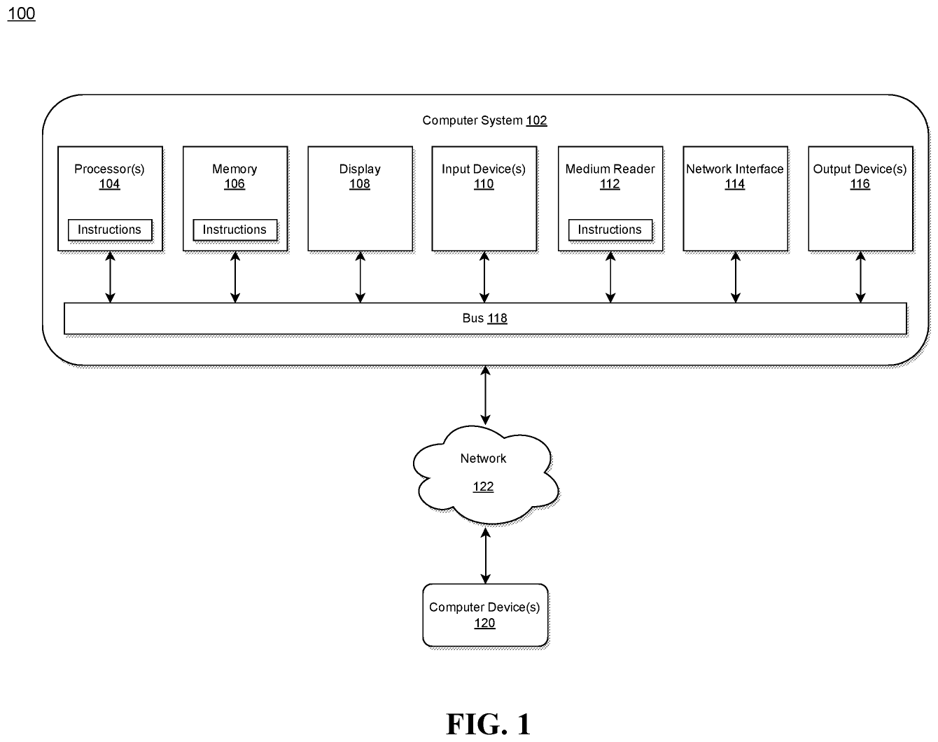

FIG. 1 is an exemplary system 100 for use in implementing a platform, language, database, and cloud agnostic technology learning module configured to create a technical accelerator learning environment that provides an immersive, hands-on practical learning environment in accordance with an exemplary embodiment. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the technology learning module may be platform, language, database, and cloud agnostic that may allow for consistent easy orchestration and passing of data through various components to output a desired result regardless of platform, language, database, and cloud environment. Since the disclosed process, according to exemplary embodiments, is platform, language, database, and cloud agnostic, the technology learning module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

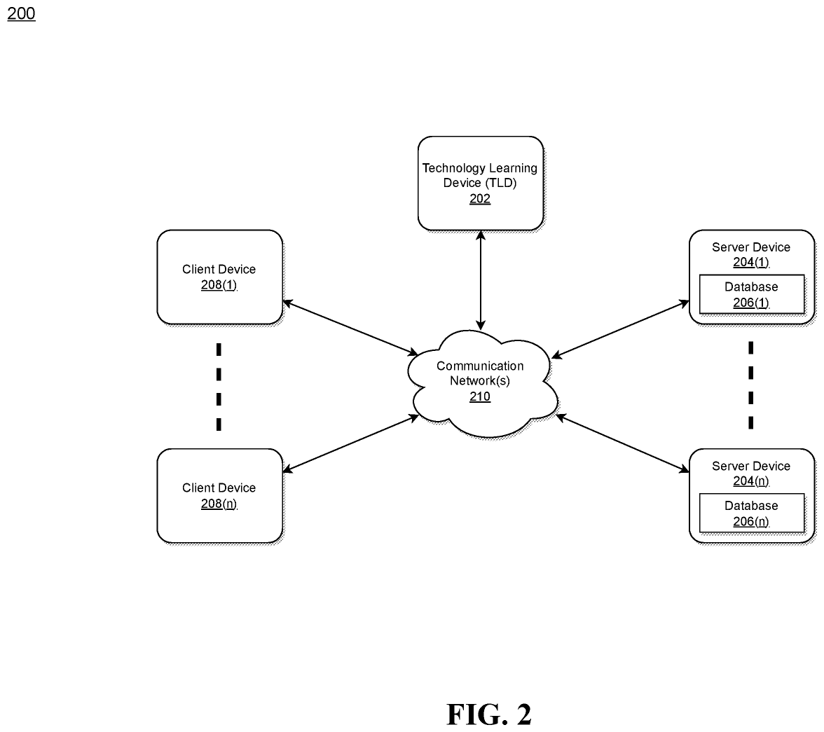

Referring to FIG. 2, a schematic of an exemplary network environment 200 for implementing a language, platform, database, and cloud agnostic technology learning device (TLD) of the instant disclosure is illustrated.

According to exemplary embodiments, the above-described problems associated with conventional tools may be overcome by implementing a TLD 202 as illustrated in FIG. 2 that may be configured for implementing a platform, language, database, and cloud agnostic technology learning module configured to create a technical accelerator learning environment that provides an immersive, hands-on practical learning environment that allows users, i.e., software developers, to experience new technologies and internal technologies safely, securely, confidently, and at their own pace, but the disclosure is not limited thereto.

The TLD 202 may be the same or similar to the computer system 102 as described with respect to FIG. 1.

The TLD 202 may store one or more applications that can include executable instructions that, when executed by the TLD 202, cause the TLD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the TLD 202 itself, may be located in virtual server(s) running in a cloud-based computing environment rather than being tied to one or more specific physical network computing devices. Also, the application(s) may be running in one or more virtual machines (VMs) executing on the TLD 202. Additionally, in one or more embodiments of this technology, virtual machine(s) running on the TLD 202 may be managed or supervised by a hypervisor.

In the network environment 200 of FIG. 2, the TLD 202 is coupled to a plurality of server devices 204(1)-204 (n) that hosts a plurality of databases 206(1)-206 (n), and also to a plurality of client devices 208(1)-208 (n) via communication network(s) 210. A communication interface of the TLD 202, such as the network interface 114 of the computer system 102 of FIG. 1, operatively couples and communicates between the TLD 202, the server devices 204(1)-204 (n), and/or the client devices 208(1)-208 (n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TLD 202, the server devices 204(1)-204 (n), and/or the client devices 208(1)-208 (n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The TLD 202 may be a standalone device or integrated with one or more other devices or apparatuses, such as one or more of the server devices 204(1)-204 (n), for example. In one particular example, the TLD 202 may be hosted by one of the server devices 204(1)-204 (n), and other arrangements are also possible. Moreover, one or more of the devices of the TLD 202 may be in the same or a different communication network including one or more public, private, or cloud networks, for example.

The plurality of server devices 204(1)-204 (n) may be the same or similar to the computer system 102 or the computer device 120 as described with respect to FIG. 1, including any features or combination of features described with respect thereto. For example, any of the server devices 204(1)-204 (n) may include, among other features, one or more processors, a memory, and a communication interface, which are coupled together by a bus or other communication link, although other numbers and/or types of network devices may be used. The server devices 204(1)-204 (n) in this example may process requests received from the TLD 202 via the communication network(s) 210 according to the HTTP-based and/or JavaScript Object Notation (JSON) protocol, for example, although other protocols may also be used.

The server devices 204(1)-204 (n) may be hardware or software or may represent a system with multiple servers in a pool, which may include internal or external networks. The server devices 204(1)-204 (n) hosts the databases 206(1)-206 (n) that are configured to store metadata sets, data quality rules, and newly generated data.

Although the server devices 204(1)-204 (n) are illustrated as single devices, one or more actions of each of the server devices 204(1)-204 (n) may be distributed across one or more distinct network computing devices that together comprise one or more of the server devices 204(1)-204 (n). Moreover, the server devices 204(1)-204 (n) are not limited to a particular configuration. Thus, the server devices 204(1)-204 (n) may contain a plurality of network computing devices that operate using a master/slave approach, whereby one of the network computing devices of the server devices 204(1)-204 (n) operates to manage and/or otherwise coordinate operations of the other network computing devices.

The server devices 204(1)-204 (n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208 (n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204 (n) or other client devices 208(1)-208 (n).

According to exemplary embodiments, the client devices 208(1)-208 (n) in this example may include any type of computing device that can facilitate the implementation of the TLD 202 that may efficiently provide a platform for implementing a platform, language, database, and cloud agnostic technology learning module configured to create a technical accelerator learning environment that provides an immersive, hands-on practical learning environment that allows users, i.e., software developers, to experience new technologies and internal technologies safely, securely, confidently, and at their own pace, but the disclosure is not limited thereto.

Although the exemplary network environment 200 with the TLD 202, the server devices 204(1)-204 (n), the client devices 208(1)-208 (n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the TLD 202, the server devices 204(1)-204 (n), or the client devices 208(1)-208 (n), for example, may be configured to operate as virtual instances on the same physical machine. For example, one or more of the TLD 202, the server devices 204(1)-204 (n), or the client devices 208(1)-208 (n) may operate on the same physical device rather than as separate devices communicating through communication network(s) 210. Additionally, there may be more or fewer TLDs 202, server devices 204(1)-204 (n), or client devices 208(1)-208 (n) than illustrated in FIG. 2. According to exemplary embodiments, the TLD 202 may be configured to send code at run-time to remote server devices 204(1)-204 (n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

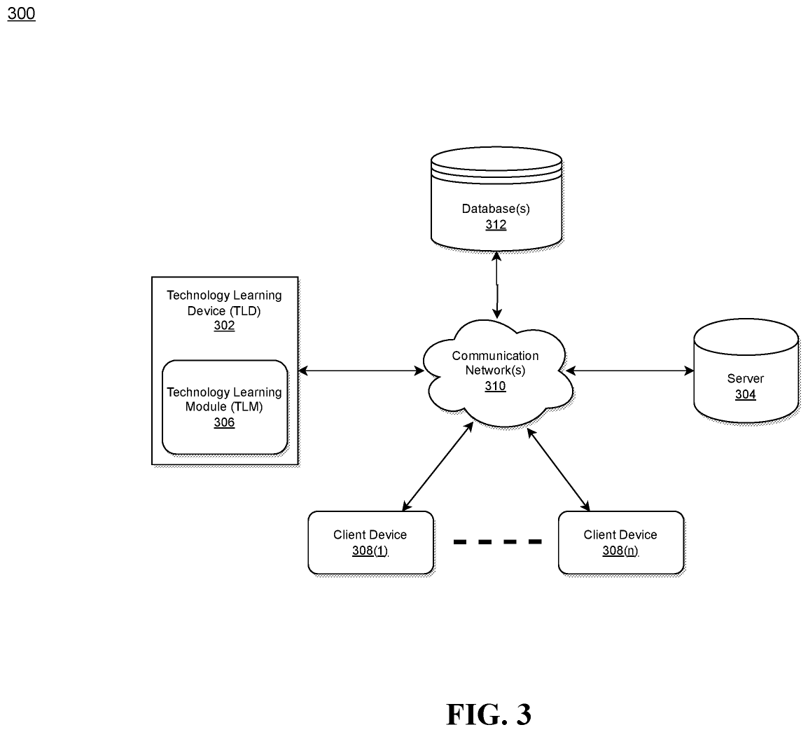

FIG. 3 illustrates a system diagram for implementing a platform, language, and cloud agnostic TLD having a platform, language, database, and cloud agnostic technology learning module (TLM) in accordance with an exemplary embodiment.

As illustrated in FIG. 3, the system 300 may include a TLD 302 within which an TLM 306 is embedded, a server 304, a database(s) 312, a plurality of client devices 308(1) . . . 308 (n), and a communication network 310.

According to exemplary embodiments, the TLD 302 including the TLM 306 may be connected to the server 304, and the database(s) 312 via the communication network 310. The TLD 302 may also be connected to the plurality of client devices 308(1) . . . 308 (n) via the communication network 310, but the disclosure is not limited thereto.

According to exemplary embodiment, the TLD 302 is described and shown in FIG. 3 as including the TLM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) may be a mainframe database, a log database that may produce programming for searching, monitoring, and analyzing machine-generated data via a web interface, etc., but the disclosure is not limited thereto.

According to exemplary embodiments, the TLM 306 may be configured to receive real-time feed of data from the plurality of client devices 308(1) . . . 308 (n) and secondary sources via the communication network 310.

As may be described below, the TLM 306 may be configured to: build a plurality of containers each including self-learning instructions and tutorials corresponding to a particular internal or new organization specific technology needed to be learned by a user that are not otherwise available via a third party learning platform: implement a process to configure each container in a manner such that each container can be hosted on an isolated learning environment: host, in response to implementing the process, each processed container onto a public cloud environment and a private cloud environment; receive, via a browser, user input corresponding to login credentials associated with the user: receive, upon successful login, user requests that identify user desired instructions and tutorials corresponding to the particular internal or new organization specific technology: automatically provisions, in response to receiving the user requests, the isolated learning environment for hosting the processed containers that include the identified user desired instructions and tutorials; and automatically implement a platform that allows the user to self-learn, by utilizing the isolated learning environment, the particular internal or new organization specific technology, but the disclosure is not limited thereto.

The plurality of client devices 308(1) . . . 308 (n) are illustrated as being in communication with the TLD 302. In this regard, the plurality of client devices 308(1) . . . 308 (n) may be “clients” (e.g., customers) of the TLD 302 and are described herein as such. Nevertheless, it is to be known and understood that the plurality of client devices 308(1) . . . 308 (n) need not necessarily be “clients” of the TLD 302, or any entity described in association therewith herein. Any additional or alternative relationship may exist between either or both of the plurality of client devices 308(1) . . . 308 (n) and the TLD 302, or no relationship may exist.

The first client device 308(1) may be, for example, a smart phone. Of course, the first client device 308(1) may be any additional device described herein. The second client device 308 (n) may be, for example, a personal computer (PC). Of course, the second client device 308 (n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308 (n) may communicate with the TLD 302 via broadband or cellular communication. Of course, these embodiments are merely exemplary and are not limiting or exhaustive.

The computing device 301 may be the same or similar to any one of the client devices 208(1)-208 (n) as described with respect to FIG. 2, including any features or combination of features described with respect thereto. The TLD 302 may be the same or similar to the TLD 202 as described with respect to FIG. 2, including any features or combination of features described with respect thereto.

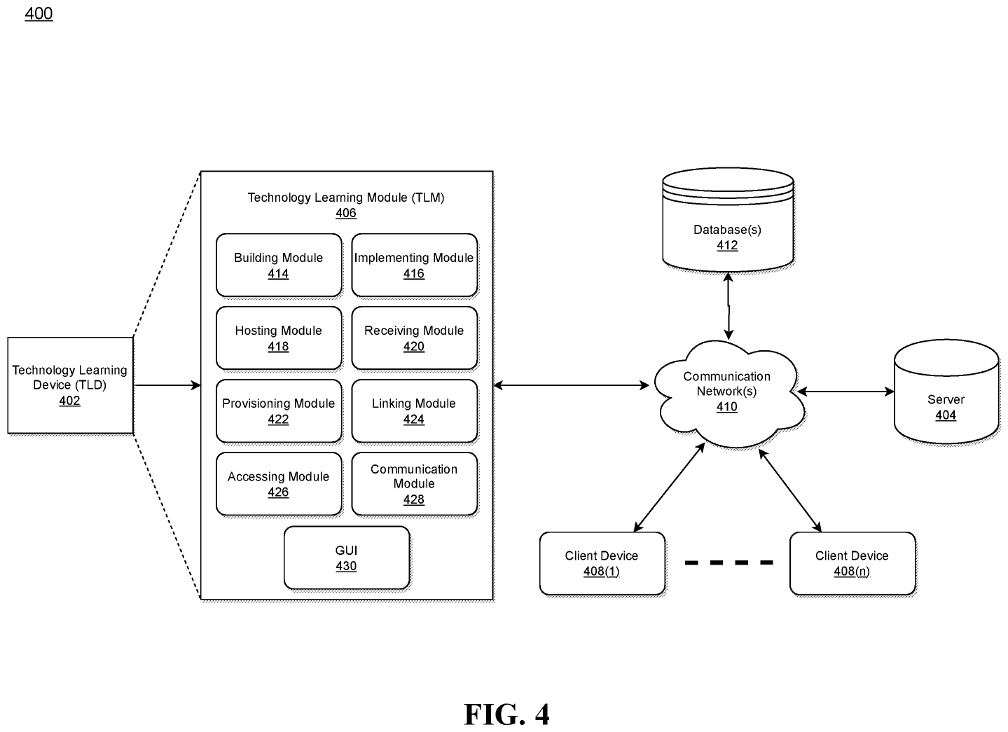

FIG. 4 illustrates a system diagram for implementing a platform, language, database, and cloud agnostic TLM of FIG. 3 in accordance with an exemplary embodiment.

According to exemplary embodiments, the system 400 may include a platform, language, database, and cloud agnostic TLD 402 within which a platform, language, database, and cloud agnostic TLM 406 is embedded, a server 404, database(s) 412, and a communication network 410. According to exemplary embodiments, server 404 may comprise a plurality of servers located centrally or located in different locations, but the disclosure is not limited thereto.

According to exemplary embodiments, the TLD 402 including the TLM 406 may be connected to the server 404 and the database(s) 412 via the communication network 410. The TLD 402 may also be connected to the plurality of client devices 408(1)-408 (n) via the communication network 410, but the disclosure is not limited thereto. The TLM 406, the server 404, the plurality of client devices 408(1)-408 (n), the database(s) 412, the communication network 410 as illustrated in FIG. 4 may be the same or similar to the TLM 306, the server 304, the plurality of client devices 308(1)-308 (n), the database(s) 312, the communication network 310, respectively, as illustrated in FIG. 3.

According to exemplary embodiments, as illustrated in FIG. 4, the TLM 406 may include a building module 414, an implementing module 416, a hosting module 418, a receiving module 420, a provisioning module 422, a linking module 424, an accessing module 426, a communication module 428, and a GUI 430. According to exemplary embodiments, interactions and data exchange among these modules included in the TLM 406 provide the advantageous effects of the disclosed invention. Functionalities of each module of FIG. 4 may be described in detail below with reference to FIGS. 4-6.

According to exemplary embodiments, each of the building module 414, implementing module 416, hosting module 418, receiving module 420, provisioning module 422, linking module 424, accessing module 426, and the communication module 428 of the TLM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the building module 414, implementing module 416, hosting module 418, receiving module 420, provisioning module 422, linking module 424, accessing module 426, and the communication module 428 of the TLM 406 of FIG. 4 may be implemented by microprocessors or similar, and may be programmed using software (e.g., microcode) to perform various functions discussed herein and may optionally be driven by firmware and/or software.

Alternatively, according to exemplary embodiments, each of the building module 414, implementing module 416, hosting module 418, receiving module 420, provisioning module 422, linking module 424, accessing module 426, and the communication module 428 of the TLM 406 of FIG. 4 may be implemented by dedicated hardware, or as a combination of dedicated hardware to perform some functions and a processor (e.g., one or more programmed microprocessors and associated circuitry) to perform other functions.

According to exemplary embodiments, each of the building module 414, implementing module 416, hosting module 418, receiving module 420, provisioning module 422, linking module 424, accessing module 426, and the communication module 428 of the TLM 406 of FIG. 4 may be called via corresponding API.

According to exemplary embodiments, the process implemented by the TLM 406 may be executed via the communication module 428 and the communication network 410, which may comprise plural networks as described above. For example, in an exemplary embodiment, the various components of the TLM 406 may communicate with the server 404, and the database(s) 412 via the communication module 428 and the communication network 410. Of course, these embodiments are merely exemplary and are not limiting or exhaustive. The database(s) 412 may include the databases included within the private cloud and/or public cloud and the server 404 may include one or more servers within the private cloud and the public cloud.

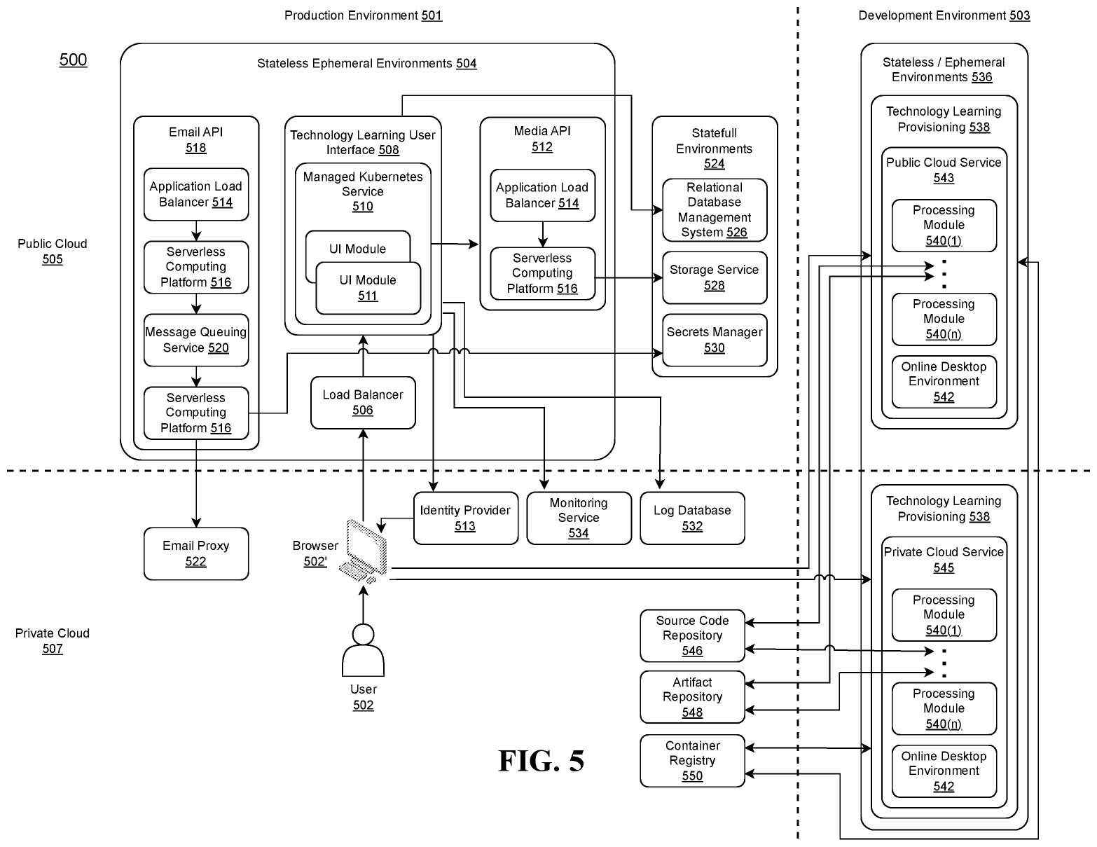

For example, FIG. 5 illustrates an exemplary architecture 500 implemented by the platform, language, database, and cloud agnostic TLM 406 of FIG. 4 for creating a technical accelerator learning environment in accordance with an exemplary embodiment. As illustrated in FIG. 5, the exemplary architecture 500 may include a production environment 501 and a development environment 503. The production environment 501 may be hosted onto a public cloud 505 and private cloud 507.

According to exemplary embodiments, within the public cloud 505, stateless/ephemeral environments 504 and stateful environments 524 may be hosted. The stateless/ephemeral environments 504 may include components such as email API 518: a technology learning user interface 508, a load balancer 506, and a media API. The email API 518 may correspond to components such as an application load balancer 514, message queuing service 520 and a serverless computing platform 516 both before and after the message queuing service 520.

According to exemplary embodiments, stateful environment or architecture or application describes a structure that allows users to store, record, and return to already established information and processes over the internet. It may entail transactions that are performed using past transactions as a reference point. In stateful environments or applications, the current transaction can be affected by the previous ones. Because of this, a stateful environment or application uses the same server to process its requests.

According to exemplary embodiments, a stateless environment or architecture or application is a type of Internet protocol where the state of the previous transactions is neither stored nor referenced in subsequent transactions. Each request sent between the sender and receiver can be interpreted and does not need earlier requests for its execution. This is a protocol where a client and server request and response are made in a current state. In addition, the status of the current session is not retained or carried over to the next transaction.

According to exemplary embodiments, an ephemeral environment is a temporary, encapsulated deployment of a software application. Ephemeral environments provide robust, on-demand platforms for running tests, previewing features, and collaborating asynchronously across teams.

According to exemplary embodiments, the application load balancer 514 may be configured in a manner such that after the application load balancer 514 receives a request, it evaluates the listener rules in priority order to determine which rule to apply, and then selects a target from the target group for the rule action. Listener rules can be configured to route requests to different target groups based on the content of the application traffic.

According to exemplary embodiments, the serverless computing platform 516 may be configured to provide a computing service that runs code in response to events and automatically manages the computing resources required by that code.

According to exemplary embodiments, the message queuing service 520 may be configured to provide supports corresponding to programmatic sending of messages via web service applications as a way to communicate over the Internet.

According to exemplary embodiments, the secrets manager 530 may be configured in a manner such that it can securely encrypts and centrally audits secrets such as database credentials and API keys. According to exemplary embodiments, the secrets manager 530 may manage access to secrets using fine-grained AWS Identity and Access Management (IAM) and resource-based policies and rotate secrets automatically to meet security and compliance requirements. According to exemplary embodiments, AWS Lambda can be utilized to automatically rotate secrets on a schedule.

According to exemplary embodiments, the technology learning user interface 508 may include components such as managed Kubernetes service 510 and a plurality of user interface modules 511.

According to exemplary embodiments, the media API 512 may also correspond to components such as the application load balancer 514 and the serverless computing platform 516.

According to exemplary embodiments, the stateful environments 524 hosted within the public cloud 505 side of the production environment 501 may include components such as a relational database management system (RDMS) 526, a storage service 528, and secrets manager 530.

According to exemplary embodiments, the stateless/ephemeral environments 536 hosted within the public cloud 505 side of the development environment 503 may include a component such as technology learning provisioning 538 which may include public cloud service 543 for hosting one or more processing modules 540(1)-540 (n) and an online desktop environment 542.

According to exemplary embodiments, the production environment 501 hosted on the private cloud 507 may include components such as an email proxy 522 received from the serverless computing platform 516 via the email API 518, a browser 502′, an identity provider 513, a monitoring service 534, a log database 532, a source code repository 546, an artifact repository 548, and a container registry 530.

According to exemplary embodiments, the development environment 503 hosted on the private cloud 507 may also include the component such as the technology learning provisioning 538 which may include private cloud service 545 for hosting the one or more processing modules 540(1)-540 (n) and the online desktop environment 542.

According to exemplary embodiments, the online desktop environment 542 may be configured to allow easy integration of single-page web applications and provide them with file menu operations and the required user interface.

According to exemplary embodiments, the exemplary architecture 500 implemented by the TLM 406 may be configured to create a technical accelerator learning environment that provides an immersive, hands-on practical learning environment that allows users, i.e., software developers, to experience new technologies and internal technologies safely, securely, confidently, and at their own pace, but the disclosure is not limited thereto.

For example, the exemplary architecture 500 implemented by the TLM 406 may be configured to: improve the user experience and help users gain hands-on knowledge to modernize applications: offer support for those who are new to an organization and public cloud all the way through to those who have extensive experience of both: support public cloud environment to unlock public cloud at scale that is needed to provide the ability for users to learn through hands-on practical experiences, and to easily apply that knowledge efficiently and effective: provide learning experiences accessible to all irrespective of their desktop infrastructure, role, and tenure: support experimentation and exploration through disposable environments: support learning experiences anytime, anywhere at the time of need-users can start learning in seconds or minutes with no pre-requisites (i.e., entitlements or onboarding activities, etc.); provide locked down, isolated environments ensuring learners only have access to what they need-no risk of destroying their own development environments: provide a zero-install model with no local infrastructure requirements-everything may be accessible from a browser so that every logged in user doesn't need to request for any accesses or install anything; provide organization specific step-by-step tutorials to users of all abilities, roles, or tenures across a variety of topics, etc., but the disclosure is not limited thereto.

For example, referring to FIGS. 4 and 5 hereinafter, the building module 414 may be configured to build a plurality of containers each including self-learning instructions and tutorials corresponding to a particular internal or new organization specific technology needed to be learned by a user that are not otherwise available via a third party learning platform.

The implementing module 416 may be configured to implement a process to configure each container in a manner such that each container can be hosted on an isolated learning environment. The hosting module 418 may be configured to host, in response to implementing the process, each processed container onto a public cloud environment, i.e., within the public cloud service 543 and a private cloud environment, i.e., within the private cloud service 545.

For example, according to exemplary embodiments, the receiving module 420 may be configured to receive, via the browser 502′, user input corresponding to login credentials associated with the user 502. The receiving module 420 may also be configured to receive, upon successful login, user requests from the user 502 that identify user desired instructions and tutorials corresponding to the particular internal or new organization specific technology.

According to exemplary embodiments, the provisioning module 422 may be configured to automatically provision, in response to receiving the user requests from the user 502, the isolated learning environment for hosting the processed containers that include the identified user desired instructions and tutorials.

According to exemplary embodiments the implementing module 416 may be configured to automatically implement a platform, i.e., a technical accelerator learning environment, that allows the user to self-learn, by utilizing the isolated learning environment, the particular internal or new organization specific technology.

According to exemplary embodiments, the linking module 424 may be configured to link the processed containers with the identity provider 513, wherein the identify provider 513 verifies the login credentials for allowing access to the processed containers processed by the processing modules 540(1)-540 (n). And once logged in, the user 502 does not need to request any access permissions or install any tools or applications onto the user's own workspace development environment for accessing other processed containers processed by the processing modules 540(1)-540 (n).

According to exemplary embodiments, the provisioning module 422 may be further configured to automatically provision the isolated learning environment in a manner such that the provisioned learning environment enables the user 502 to access or open files from the processed containers processed by the processing modules 540(1)-540 (n) to self-learn the particular internal or new organization specific technology based on corresponding instructions and tutorials without affecting the user's own workspace development environment.

According to exemplary embodiments, the provisioning module 422 may be further configured to asynchronously provision the isolated learning environment exclusive to the user 502 instantaneously.

According to exemplary embodiments, the TLM 406 may be configured to send assessment results to assessment creators on a periodic basis (nightly). Alternatively, the TLM 406 may implement a self-service dashboard for the assessment creators to access the assessment results.

According to exemplary embodiments, the communication module 428 may be further configured to establish a connection to the isolated learning environment via a Uniform Resource Locator (URL) link through the browser 502′. The accessing module 426 may be configured to allow access to the corresponding processed containers to self-learn the particular internal or new organization specific technology based on corresponding instructions and tutorials at the user's own pace.

According to exemplary embodiments, the TLM 406 may be further configured to invoke corresponding provisioning application programming interface to automatically provision the isolated learning environment exclusive to the user 502 based on the identified user desired instructions and tutorials.

According to exemplary embodiments, the provisioning module 422 may be further configured to automatically provision corresponding isolated learning environment for each user in a multi-tenant configuration as a dedicated environment such that users can spin up or tear down the dedicated environment on demand.

According to exemplary embodiments, the hosting module 418 may be further configured to host the isolated learning environment onto the private cloud 507 and the public cloud 505 in a manner such that the users can access the processed containers having corresponding instructions and tutorials directly, wherein there is no contention for resources because each user gets a dedicated learning environment.

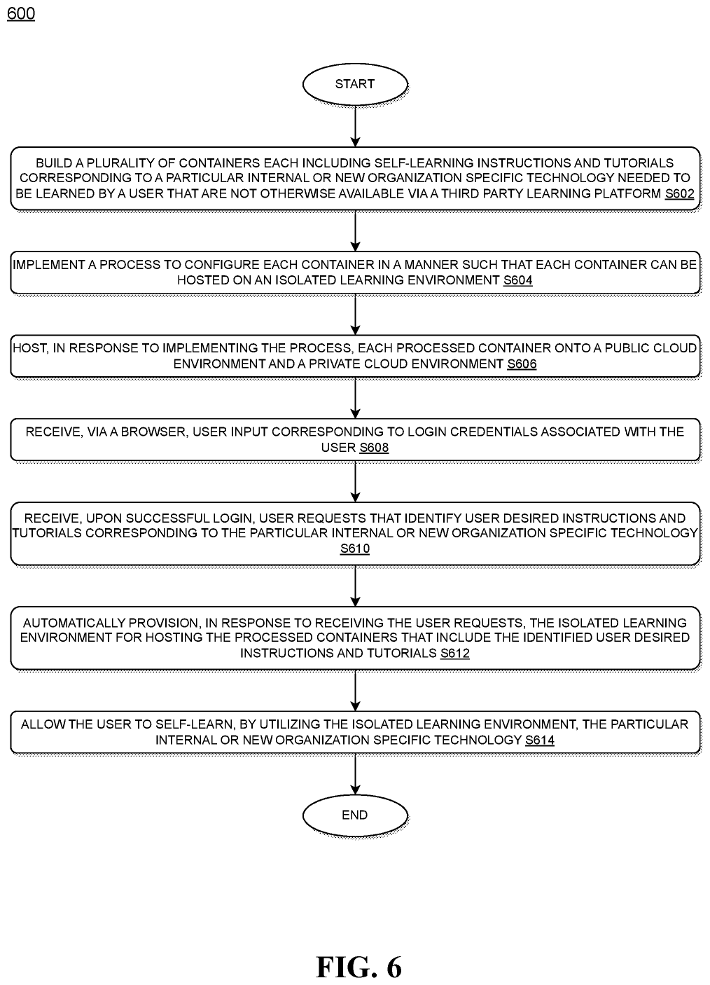

Referring back to FIG. 6, upon receiving user input and requests from the user 502 via the browser 502′, data may first flow from the browser 502′ to the load balancer 506. Data from the load balancer 506 may flow to the technology learning user interface 508 and get processed accordingly by the managed Kubernetes service 510 by utilizing the user interface modules 511. Output data from the managed Kubernetes service 510 may be input to the media API 512 for further processing by the application load balancer 514 and the serverless computing platform 516. Output data from the serverless computing platform 516 within the media API 512 may be input to the storage service 528 within the stateful environments 524.

According to exemplary embodiments, output data from the technology learning user interface 508 may be input to the RDMS 526 within the stateful environments 524, the identity provider 513, the monitoring service 534, and the log database 532 within the private cloud 507 environment. And output data from the identity provider 513 may be input to the browser 502′ to approve login for the user 502.

Each of the source code repository 546, the artifact repository 548, and the container registry 550 may be bi-directionally connected to the technology learning provisioning 538 hosted on both development environment 503 in the public cloud 505 and private cloud 507 to exchange data. For example, the source code repository 546 may be bi-directionally connected to the processing modules 540(1)-540 (n) hosted on both public cloud service 543 and private cloud service 545 to exchange data. The artifact repository 548 may also be bi-directionally connected to the processing modules 540(1)-540 (n) hosted on both the public cloud service 543 and the private cloud service 545 to exchange data. Each of the processing modules 540(1)-540 (n) implements a process called “sandbox” which is an isolated environment that enables users to run programs or open files without affecting the application, system, or platform on which they run.

According to exemplary embodiments, the monitoring server 534 may be configured in a manner such that it can provide a cloud infrastructure monitoring service with a dashboard, alerting, and visualizations of metrics.

According to exemplary embodiments, the artifact repository 548 may be configured in a manner such that it can provide end-to-end automation and management of binaries and artifacts through the application delivery process that improves productivity across development ecosystem.

According to exemplary embodiments, the container registry 550 may be configured in a manner such that it can act as a repository manager, which supports Docker and Helm registries and Generic repositories, allowing the user 502 to build, deploy and manage his/her container images while providing powerful features with fine-grained permission control behind an easy-to-use user interface.

FIG. 6 illustrates an exemplary flow chart of a process 600 implemented by the platform, language, database, and cloud agnostic TLM 406 of FIG. 4 for implementing a platform for self-learning technologies in accordance with an exemplary embodiment. It may be appreciated that the illustrated process 600 and associated steps may be performed in a different order, with illustrated steps omitted, with additional steps added, or with a combination of reordered, combined, omitted, or additional steps.

As illustrated in FIG. 6, at step S602, the process 600 may include building a plurality of containers each including self-learning instructions and tutorials corresponding to a particular internal or new organization specific technology needed to be learned by a user that are not otherwise available via a third party learning platform.

At step S604, the process 600 may include implementing a process to configure each container in a manner such that each container can be hosted on an isolated learning environment.

At step S606, the process 600 may include hosting, in response to implementing the process, each processed container onto a public cloud environment and a private cloud environment.

At step S608, the process 600 may include receiving, via a browser, user input corresponding to login credentials associated with the user.

At step S610, the process 600 may include receiving, upon successful login, user requests that identify user desired instructions and tutorials corresponding to the particular internal or new organization specific technology.

At step S612, the process 600 may include automatically provisioning, in response to receiving the user requests, the isolated learning environment for hosting the processed containers that include the identified user desired instructions and tutorials.

At step S614, the process 600 may include automatically implementing a platform that allows the user to self-learn, by utilizing the isolated learning environment, the particular internal or new organization specific technology.

According to exemplary embodiments, the process 600 may further include linking the processed containers with an identity provider, wherein the identify provider verifies the login credentials for allowing access to the processed containers, and once logged in, the user does not need to request any access permissions or install any tools or applications onto the user's own workspace development environment for accessing other processed containers.

According to exemplary embodiments, the process 600 may further include automatically provisioning the isolated learning environment in a manner such that the provisioned learning environment enables a user to access or open files from the processed container to self-learn the particular internal or new organization specific technology based on corresponding instructions and tutorials without affecting the user's own workspace development environment.

According to exemplary embodiments, in the process 600, the browser is operatively connected to the private cloud environment and the public cloud environment.

According to exemplary embodiments, in the process 600, each of the private cloud environment and the public cloud environment is stateless or ephemeral such that each request sent between a sender and a receiver can be interpreted and does not need earlier requests for its execution.

According to exemplary embodiments, the process 600 may further include asynchronously provisioning the isolated learning environment exclusive to said user instantaneously.

According to exemplary embodiments, the process 600 may further include establishing a connection to the isolated learning environment via a URL link through the browser; and allowing access to the corresponding processed containers to self-learn the particular internal or new organization specific technology based on corresponding instructions and tutorials at the user's own pace.

According to exemplary embodiments, the process 600 may further include invoking corresponding provisioning application programming interface to automatically provision the isolated learning environment exclusive to said user based on the identified user desired instructions and tutorials.

According to exemplary embodiments, the process 600 may further include automatically provisioning corresponding isolated learning environment for each user in a multi-tenant configuration as a dedicated environment such that users can spin up or tear down the dedicated environment on demand.

According to exemplary embodiments, the process 600 may further include hosting the isolated learning environment onto the private cloud and the public cloud in a manner such that the users can access the processed containers having corresponding instructions and tutorials directly, wherein there is no contention for resources because each user gets a dedicated learning environment.

According to exemplary embodiments, the TLD 402 may include a memory (e.g., a memory 106 as illustrated in FIG. 1) which may be a non-transitory computer readable medium that may be configured to store instructions for implementing a platform, language, database, and cloud agnostic TLM 406 for automatically implementing a platform for self-learning technologies as disclosed herein. The TLD 402 may also include a medium reader (e.g., a medium reader 112 as illustrated in FIG. 1) which may be configured to read any one or more sets of instructions, e.g., software, from any of the memories described herein. The instructions, when executed by a processor embedded within the TLM 406 or within the TLD 402, may be used to perform one or more of the methods and processes as described herein. In a particular embodiment, the instructions may reside completely, or at least partially, within the memory 106, the medium reader 112, and/or the processor 104 (see FIG. 1) during execution by the TLD 402.

According to exemplary embodiments, the instructions, when executed, may cause a processor embedded within the TLM 406, or the TLD 402 to perform the following: building a plurality of containers each including self-learning instructions and tutorials corresponding to a particular internal or new organization specific technology needed to be learned by a user that are not otherwise available via a third party learning platform; implementing a process to configure each container in a manner such that each container can be hosted on an isolated learning environment: hosting, in response to implementing the process, each processed container onto a public cloud environment and a private cloud environment: receiving, via a browser, user input corresponding to login credentials associated with the user; receiving, upon successful login, user requests that identify user desired instructions and tutorials corresponding to the particular internal or new organization specific technology: automatically provisioning, in response to receiving the user requests, the isolated learning environment for hosting the processed containers that include the identified user desired instructions and tutorials; and automatically implementing a platform that allows the user to self-learn, by utilizing the isolated learning environment, the particular internal or new organization specific technology. According to exemplary embodiments, the processor may be the same or similar to the processor 104 as illustrated in FIG. 1 or the processor embedded within TLD 202, TLD 302, TLD 402, and TLM 406 which may be the same or similar to the processor 104.

According to exemplary embodiments, the instructions, when executed, may further cause the processor 104 to perform the following: linking the processed containers with an identity provider, wherein the identify provider verifies the login credentials for allowing access to the processed containers, and once logged in, the user does not need to request any access permissions or install any tools or applications onto the user's own workspace development environment for accessing other processed containers.

According to exemplary embodiments, the instructions, when executed, may further cause the processor 104 to perform the following: automatically provisioning the isolated learning environment in a manner such that the provisioned learning environment enables a user to access or open files from the processed container to self-learn the particular internal or new organization specific technology based on corresponding instructions and tutorials without affecting the user's own workspace development environment.

According to exemplary embodiments, the instructions, when executed, may further cause the processor 104 to perform the following: asynchronously provisioning the isolated learning environment exclusive to said user instantaneously.

According to exemplary embodiments, the instructions, when executed, may further cause the processor 104 to perform the following: establishing a connection to the isolated learning environment via a uniform resource locator link through the browser; and allowing access to the corresponding processed containers to self-learn the particular internal or new organization specific technology based on corresponding instructions and tutorials at the user's own pace.

According to exemplary embodiments, the instructions, when executed, may further cause the processor 104 to perform the following: invoking corresponding provisioning application programming interface to automatically provision the isolated learning environment exclusive to said user based on the identified user desired instructions and tutorials.

According to exemplary embodiments, the instructions, when executed, may further cause the processor 104 to perform the following: automatically provisioning corresponding isolated learning environment for each user in a multi-tenant configuration as a dedicated environment such that users can spin up or tear down the dedicated environment on demand.

According to exemplary embodiments, the instructions, when executed, may further cause the processor 104 to perform the following: hosting the isolated learning environment onto the private cloud and the public cloud in a manner such that the users can access the processed containers having corresponding instructions and tutorials directly, wherein there is no contention for resources because each user gets a dedicated learning environment.

According to exemplary embodiments as disclosed above in FIGS. 1-6, technical improvements effected by the instant disclosure may include a platform for implementing a platform, language, database, and cloud agnostic technology learning module configured to create a technical accelerator learning environment that provides an immersive, hands-on practical learning environment that allows users, i.e., software developers, to experience new technologies and internal technologies safely, securely, confidently, and at their own pace, but the disclosure is not limited thereto. For example, according to exemplary embodiments as disclosed above in FIGS. 1-6, technical improvements effected by the instant disclosure may include a platform for implementing a platform, language, database, and cloud agnostic technology learning module configured to: improve the user experience and help users gain hands-on knowledge to modernize applications: offer support for those who are new to an organization and public cloud all the way through to those who have extensive experience of both: support public cloud environment to unlock public cloud at scale that is needed to provide the ability for users to learn through hands-on practical experiences, and to easily apply that knowledge efficiently and effective: provide learning experiences accessible to all irrespective of their desktop infrastructure, role, and tenure: support experimentation and exploration through disposable environments: support learning experiences anytime, anywhere at the time of need-users can start learning in seconds or minutes with no pre-requisites (i.e., entitlements or onboarding activities, etc.); provide locked down, isolated environments ensuring learners only have access to what they need-no risk of destroying their own development environments: provide a zero-install model with no local infrastructure requirements-everything may be accessible from a browser so that every logged in user doesn't need to request for any accesses or install anything: provide organization specific step-by-step tutorials to users of all abilities, roles, or tenures across a variety of topics, etc., but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for implementing a platform for self-learning technologies by utilizing one or more processors along with allocated memory, the method comprising:
implementing a platform, language, database, and cloud agnostic technology learning module (TLM) configured to improve the user experience and help users gain hands-on knowledge to modernize applications; offer support for those who are new to an organization and public cloud all the way through to those who have extensive experience of both; support public cloud environment to unlock public cloud at scale that is needed to provide the ability for users to learn through hands-on practical experiences, and to apply that knowledge efficiently and effectively; and provide locked down, isolated environments ensuring learners only have access to what they need thereby no risk of destroying their own development environments, wherein the TLM includes a building module, an implementing module, a hosting module, a receiving module, a communication module, an accessing module, and a provisioning module, and wherein each module being called via corresponding application programming interface (API);
building, by utilizing the building module, a plurality of containers each including self-learning instructions and tutorials corresponding to a particular internal or new organization specific technology needed to be learned by a user that are not otherwise available via a third party learning platform;
implementing, by utilizing the implementing module, a process to configure each container in a manner such that each container can be hosted on an isolated learning environment;
hosting, by utilizing the hosting module, in response to implementing the process, each processed container onto a public cloud environment and a private cloud environment;
receiving, via a browser, user input corresponding to login credentials associated with the user;
receiving, by utilizing the receiving module, upon successful login, user requests that identify user desired instructions and tutorials corresponding to the particular internal or new organization specific technology;
automatically provisioning, by utilizing the provisioning module, in response to receiving the user requests, the isolated learning environment for hosting the processed containers that include the identified user desired instructions and tutorials;
automatically implementing a platform that allows the user to self-learn, by utilizing the isolated learning environment, the particular internal or new organization specific technology; and
automatically provisioning the isolated learning environment in a manner such that the provisioned learning environment enables a user to access or open files from the processed container to self-learn the particular internal or new organization specific technology based on corresponding instructions and tutorials without affecting the user's own workspace development environment, wherein the communication module is configured to establish a connection to the isolated learning environment via a Uniform Resource Locator (URL) link through a browser and the accessing module is configured to allow access to the corresponding processed containers to self-learn the particular internal or new organization specific technology based on corresponding instructions and tutorials at the user's own pace.

2. The method according to claim 1, further comprising:
linking the processed containers with an identity provider, wherein the identify provider verifies the login credentials for allowing access to the processed containers, and once logged in, the user does not need to request any access permissions or install any tools or applications onto the user's own workspace development environment for accessing other processed containers.

3. (canceled)

4. The method according to claim 1, wherein the browser is operatively connected to the private cloud environment and the public cloud environment.

5. The method according to claim 4, wherein each of the private cloud environment and the public cloud environment is stateless or ephemeral such that each request sent between a sender and a receiver can be interpreted and does not need earlier requests for its execution.

6. The method according to claim 1, further comprising:
asynchronously provisioning the isolated learning environment exclusive to said user instantaneously.

7. The method according to claim 6, further comprising:
establishing a connection to the isolated learning environment via a uniform resource locator link through the browser; and
allowing access to the corresponding processed containers to self-learn the particular internal or new organization specific technology based on corresponding instructions and tutorials at the user's own pace.

8. The method according to claim 1, further comprising:
invoking corresponding provisioning application programming interface to automatically provision the isolated learning environment exclusive to said user based on the identified user desired instructions and tutorials.

9. The method according to claim 1, further comprising:
automatically provisioning corresponding isolated learning environment for each user in a multi-tenant configuration as a dedicated environment such that users can spin up or tear down the dedicated environment on demand.

10. The method according to claim 9, further comprising:
hosting the isolated learning environment onto the private cloud and the public cloud in a manner such that the users can access the processed containers having corresponding instructions and tutorials directly, wherein there is no contention for resources because each user gets a dedicated learning environment.

11. A system for implementing a platform for self-learning technologies, the system comprising:
a processor; and
a memory operatively connected to the processor via a communication interface, the memory storing computer readable instructions, when executed, causes the processor to:
implement a platform, language, database, and cloud agnostic technology learning module (TLM) configured to improve the user experience and help users gain hands-on knowledge to modernize applications; offer support for those who are new to an organization and public cloud all the way through to those who have extensive experience of both: support public cloud environment to unlock public cloud at scale that is needed to provide the ability for users to learn through hands-on practical experiences, and to apply that knowledge efficiently and effectively; and provide locked down, isolated environments ensuring learners only have access to what they need thereby no risk of destroying their own development environments, wherein the TLM includes a building module, an implementing module, a hosting module, a receiving module, a communication module, an accessing module, and a provisioning module, and wherein each module being called via corresponding application programming interface (API);
build, by utilizing the building module, a plurality of containers each including self-learning instructions and tutorials corresponding to a particular internal or new organization specific technology needed to be learned by a user that are not otherwise available via a third party learning platform;
implement, by utilizing the implementing module, a process to configure each container in a manner such that each container can be hosted on an isolated learning environment;
host, by utilizing the hosting module, in response to implementing the process, each processed container onto a public cloud environment and a private cloud environment;
receive, via a browser, user input corresponding to login credentials associated with the user;
receive, by utilizing the receiving module, upon successful login, user requests that identify user desired instructions and tutorials corresponding to the particular internal or new organization specific technology;
automatically provision, by utilizing the provisioning module, in response to receiving the user requests, the isolated learning environment for hosting the processed containers that include the identified user desired instructions and tutorials;
automatically implement a platform that allows the user to self-learn, by utilizing the isolated learning environment, the particular internal or new organization specific technology; and
automatically provision the isolated learning environment in a manner such that the provisioned learning environment enables a user to access or open files from the processed container to self-learn the particular internal or new organization specific technology based on corresponding instructions and tutorials without affecting the user's own workspace development environment, wherein the communication module is configured to establish a connection to the isolated learning environment via a Uniform Resource Locator (URL) link through a browser and the accessing module is configured to allow access to the corresponding processed containers to self-learn the particular internal or new organization specific technology based on corresponding instructions and tutorials at the user's own pace.

12. The system according to claim 11, wherein the processor is further configured to:
link the processed containers with an identity provider, wherein the identify provider verifies the login credentials for allowing access to the processed containers, and once logged in, the user does not need to request any access permissions or install any tools or applications onto the user's own workspace development environment for accessing other processed containers.

13. (canceled)

14. The system according to claim 11, wherein the browser is operatively connected to the private cloud environment and the public cloud environment.

15. The system according to claim 14, wherein each of the private cloud environment and the public cloud environment is stateless or ephemeral such that each request sent between a sender and a receiver can be interpreted and does not need earlier requests for its execution.

16. The system according to claim 11, wherein the processor is further configured to:
asynchronously provision the isolated learning environment exclusive to said user instantaneously.

17. The system according to claim 16, wherein the processor is further configured to:
establish a connection to the isolated learning environment via a uniform resource locator link through the browser; and
implement the platform to allow access to the corresponding processed containers to self-learn the particular internal or new organization specific technology based on corresponding instructions and tutorials at the user's own pace.

18. The system according to claim 11, wherein the processor is further configured to:
invoke corresponding provisioning application programming interface to automatically provision the isolated learning environment exclusive to said user based on the identified user desired instructions and tutorials.

19. The system according to claim 11, wherein the processor is further configured to:
automatically provision corresponding isolated learning environment for each user in a multi-tenant configuration as a dedicated environment such that users can spin up or tear down the dedicated environment on demand; and
host the isolated learning environment onto the private cloud and the public cloud in a manner such that the users can access the processed containers having corresponding instructions and tutorials directly, wherein there is no contention for resources because each user gets a dedicated learning environment.

20. A non-transitory computer readable medium configured to store instructions for implementing a platform for self-learning technologies, the instructions, when executed, cause a processor to perform the following:
implementing a platform, language, database, and cloud agnostic technology learning module (TLM) configured to improve the user experience and help users gain hands-on knowledge to modernize applications; offer support for those who are new to an organization and public cloud all the way through to those who have extensive experience of both; support public cloud environment to unlock public cloud at scale that is needed to provide the ability for users to learn through hands-on practical experiences, and to apply that knowledge efficiently and effectively; and provide locked down, isolated environments ensuring learners only have access to what they need thereby no risk of destroying their own development environments, wherein the TLM includes a building module, an implementing module, a hosting module, a receiving module, a communication module, an accessing module, and a provisioning module, and wherein each module being called via corresponding application programming interface (API);
building, by utilizing the building module, a plurality of containers each including self-learning instructions and tutorials corresponding to a particular internal or new organization specific technology needed to be learned by a user that are not otherwise available via a third party learning platform;
implementing, by utilizing the implementing module, a process to configure each container in a manner such that each container can be hosted on an isolated learning environment;
hosting, by utilizing the hosting module, in response to implementing the process, each processed container onto a public cloud environment and a private cloud environment;
receiving, via a browser, user input corresponding to login credentials associated with the user;
receiving, by utilizing the receiving module-via-a-fourth-API, upon successful login, user requests that identify user desired instructions and tutorials corresponding to the particular internal or new organization specific technology;
automatically provisioning, by utilizing the provisioning module, in response to receiving the user requests, the isolated learning environment for hosting the processed containers that include the identified user desired instructions and tutorials;
automatically implementing a platform that allows the user to self-learn, by utilizing the isolated learning environment, the particular internal or new organization specific technology; and
automatically provisioning the isolated learning environment in a manner such that the provisioned learning environment enables a user to access or open files from the processed container to self-learn the particular internal or new organization specific technology based on corresponding instructions and tutorials without affecting the user's own workspace development environment, wherein the communication module is configured to establish a connection to the isolated learning environment via a Uniform Resource Locator (URL) link through a browser d the accessing module is configured to allow access to the corresponding processed containers to self-learn the particular internal or new organization specific technology based on corresponding instructions and tutorials at the user's own pace.
